(19) United States
(12) Patent Application Publication
(10) Pub. No.: US 2004/0040999 A1
(43) Pub. Date: Mar. 4, 2004

(54) Multi-purpose hand-held unit

(76) Inventor: Peter Ackeret, Kusnacht (CH)

Correspondence Address: Brinks Hofer Gilson & Lione, NBC Tower Suite 3600, PO Box 10395, Chicago, IL, 60610, US

(21) Appl. No.: 10/311,701

(22) PCT Filed: Jun. 23, 2001
(86) PCT No.: PCT/EP01/07154

(30) Foreign Application Priority Data
Jun. 27, 2000 (DE) 10031313.2

(51) Int. Cl. B25C 11/00

(52) U.S. Cl. 227/63

(57) ABSTRACT

The invention relates to a multipurpose hand-held implement, in particular for office work, having a stapler which has a staple magazine (8), a staple driver (9) and an anvil (14) for folding over the ends of ejected staples, and having a component (2) which has a bearing plate (12) and a housing shell (7) with a base wall (15), which bound an accommodating space, the anvil (14) being accommodated in the region of the bearing plate (12), characterized in that the accommodating space accommodates an accommodating compartment with a drawer (28).

The invention relates to a multipurpose hand-held implement according to the preamble of claims 1 and 2.

Such multipurpose hand-held implements are known from WO 97/04924, WO 98/32570 and WO 99/20438, the last-mentioned document disclosing, in addition to a stapler and/or hole puncher, additional tools such as scissors, a knife blade, magnifying glass and the like, which are inserted into the implement in the form of an installation module and—prestressed into their storage position—can be moved via an opening mechanism, by manually actuable opening levers, into a position in which they can be swung out more easily. In its closed position, the implement serves as a handle for the respective tool. It is not possible, however, to accommodate a supply of staples for the stapler.

The object of the invention is to provide a multipurpose hand-held implement according to the preamble of claims 1 and 2 which makes it possible to carry a supply of staples.

This object is achieved according to the characterizing part of claims 1 and 2.

Further configurations of the invention can be gathered from the following description and the subclaims.

The invention is explained in more detail hereinbelow with reference to exemplary embodiments illustrated in the attached figures, in which:

FIG. 1 shows a perspective view of a multipurpose hand-held implement, the underside being at the top,

FIG. 2 shows the multipurpose hand-held implement from FIG. 1 with parts removed,

FIGS. 3 to 5 show the multipurpose hand-held implement from FIG. 1 with parts thereof in different positions,

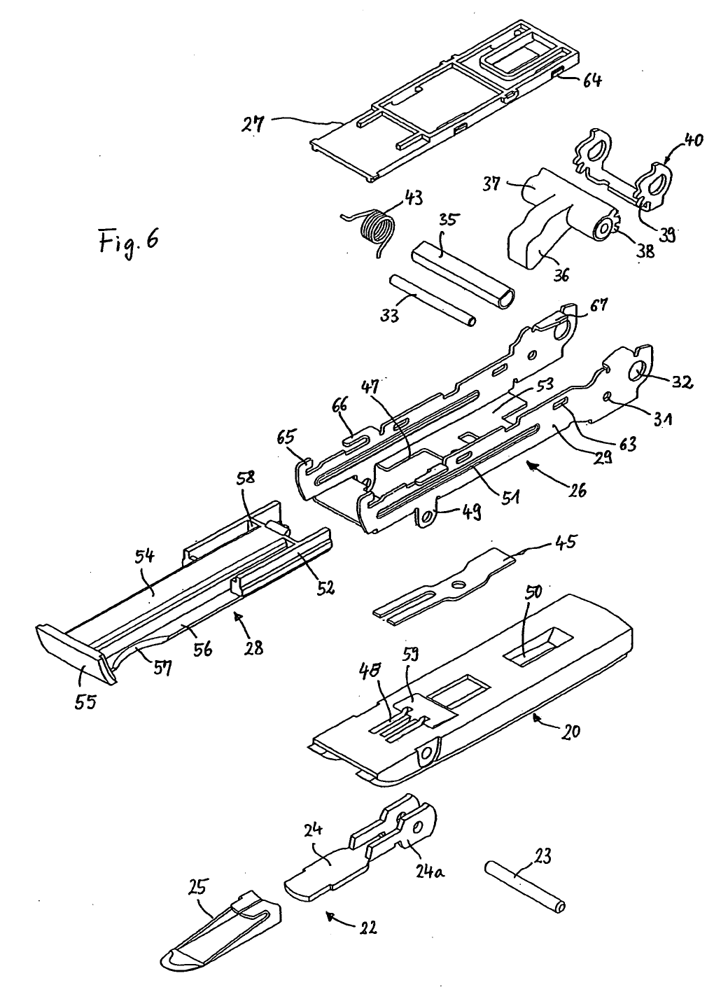

FIG. 6 shows an exploded illustration of an installation module for the multipurpose hand-held implement from FIG. 1,

FIG. 7 shows a base-side part of the multipurpose hand-held implement in longitudinal section,

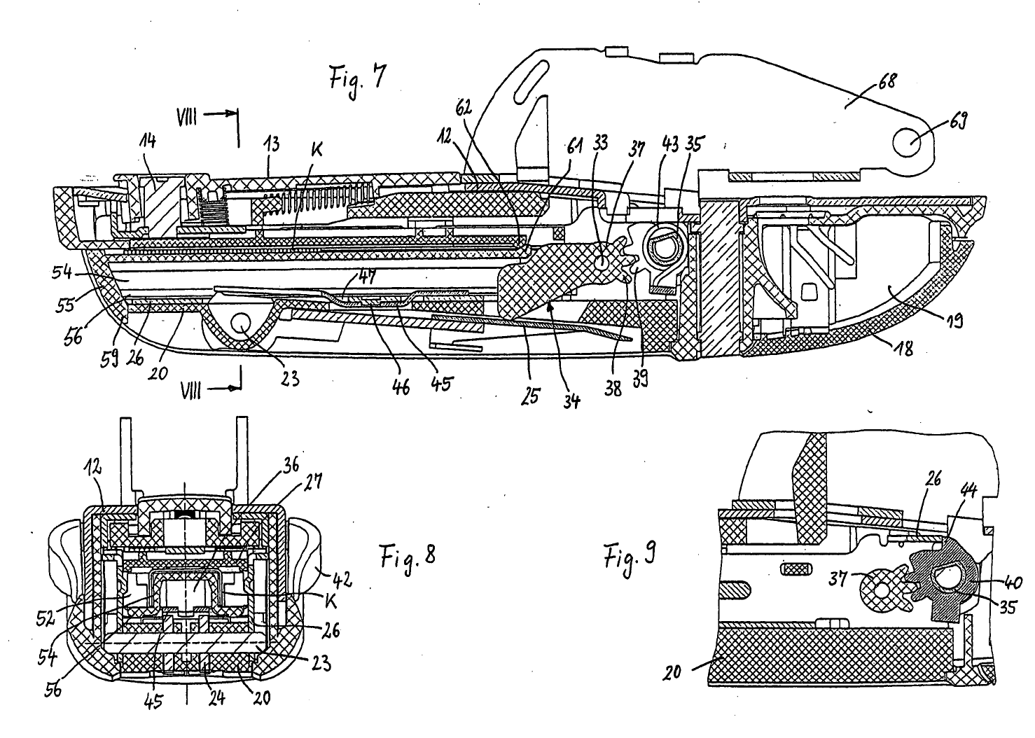

FIG. 8 shows a section along line VIII—VIII from FIG. 7,

FIG. 9 shows, in detail form, a section corresponding to line IX—IX from FIG. 8,

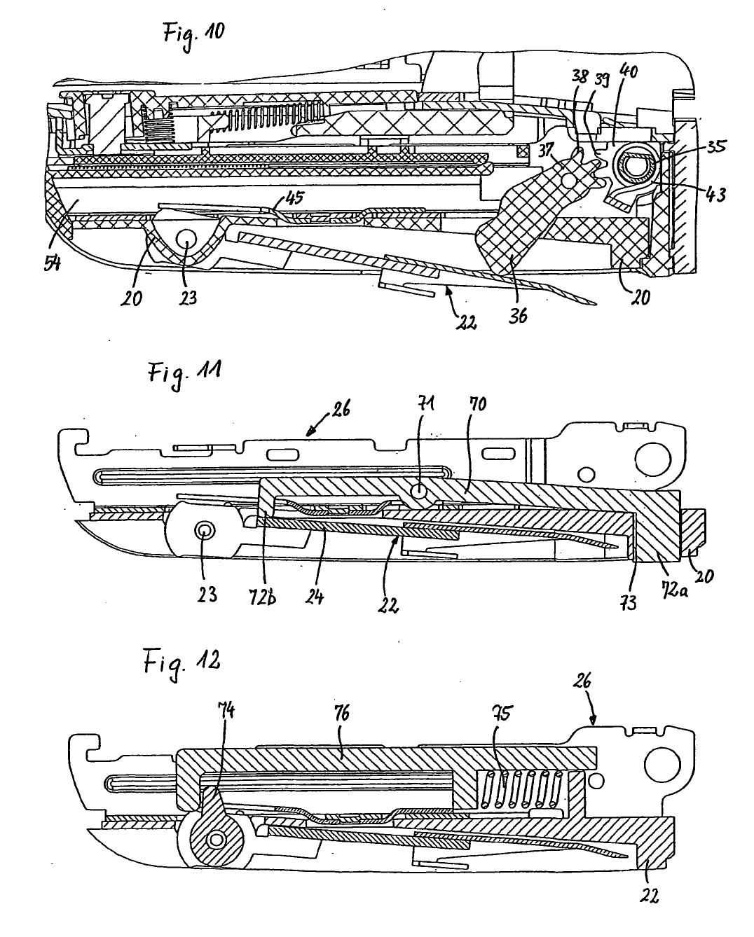

FIG. 10 shows a detail from FIG. 7 with a staple remover in a different actuating position from FIG. 7, and

FIGS. 11 to 13 show modified embodiments in a sectional view analogous to FIG. 7.

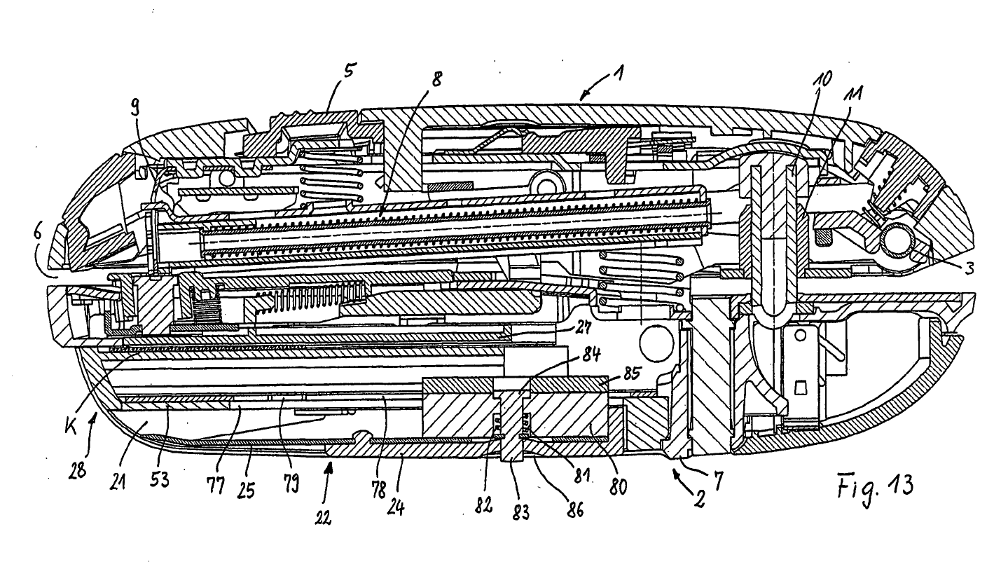

The multipurpose hand-held implement illustrated in FIG. 1 comprises a housing made up of a top-side component 1 and a base-side component 2, which are connected to one another via a swivel pin 3 and are prestressed in relation to one another by a compression spring 4 (only illustrated in FIG. 13), with the result that the two components 1, 2 can be moved between a first position, in which they form, together, an elongate, essentially closed body which is essentially cuboidal with more or less rounded edges, and a second position, in which the top-side component 1 is arranged at a predetermined opening angle in relation to the base-side component 2. The components 1, 2 can be locked in the first position by a locking mechanism, which can be released by an opening button 5.

A peripheral slot 6 is located between the two components 1, 2 in the first position. The two components 1, 2 each comprise a housing shell 7, these forming cavities in which different tools or tool parts are accommodated.

The top-side housing shell 7 accommodates a staple magazine 8 and a staple driver 9 of a stapler and, if appropriate, also a punch 10 with a guide 11 of a hole puncher (see FIG. 13). The top-side housing shell 7 here serves as a pressure-exerting lever for actuating the stapler and/or hole puncher. Details thereof are described, for example, in WO 97/04924.

The underside housing shell 7 has, adjacent to the slot 6, a bearing plate 12 of a U-shaped insert part of the component 2, said plate bearing a stapler platform 13 and an anvil 14 of the stapler, which is designed in particular as a flat-clinch stapler. If a hole puncher is additionally provided, then the die is likewise arranged in the bearing plate 12.

The underside housing shell 7 has a base wall 15 which is provided with an elongate accommodating space 16 which extends in the longitudinal direction of the housing shell 7, is open in the direction of the outside, opens out at an end side of the underside housing shell 7 and in which there is fastened an installation module 17, which is preferably inserted flush with the base wall 15.

If a hole puncher is provided, the underside housing shell 7 also has, in the region of the other end side, an accommodating compartment 19 for hole-puncher waste adjacent to the accommodating space 16, said compartment being arranged beneath the die and being provided with a lid 18.

The installation module 17 has a covering 20 which bounds a recess 21 which, like the accommodating space 16, is open in the outward direction and accommodates a staple remover 22, which can be swung out about a pin 23 which extends from the covering 20 transversely to the longitudinal direction of the base-side component 2. The said remover 22 preferably comprises a shank 24 and a head 25 fastened thereon.

The installation module 17 comprises an essentially U-shaped, elongate chassis 26 which is open at the ends and, with an intermediate base 27, forms a channel-like accommodating compartment for a drawer 28. The chassis 26 has legs 30 which are angled outward at the inner ends of its lateral side plates 29 and each have two bores 31, 32, of which the bores 31 accommodate a pin 33 for a lifting device 34 and the bores 32 accommodate a rotatably mounted sleeve 35.

The lifting device 34 comprises a lifting nose 36 which is arranged on a tube 37 mounted in a rotatable manner on the pin 33, the tube 37 being provided opposite the lifting nose 36, as seen in the circumferential direction, with teeth of a partial toothing arrangement 38. The teeth of the partial toothing arrangement 38 mesh with teeth 39 of a clip-like driver 40 which is located on the sleeve 35. The sleeve 35 and the driver 40 are connected to one another in a rotationally fixed manner. Actuating levers 42 are pressed into the sleeve 35 from the outside through corresponding openings 41a in side walls 41 of the underside housing shell 7. When the actuating lever 42 is actuated, the sleeve 35, and thus the driver 40 and, via the latter, the lifting device 34, is rotated, to be precise counter to a leg spring 43 which is mounted on the sleeve 35 and prestresses the driver 40 in relation to the chassis 26, in order to rotate the actuating lever 42 back into its starting position once it has been released. A nose 44 on the toothed segment 40 serves here as a stop which interacts with the chassis 26 in the starting position of the actuating lever 42, see FIG. 9.

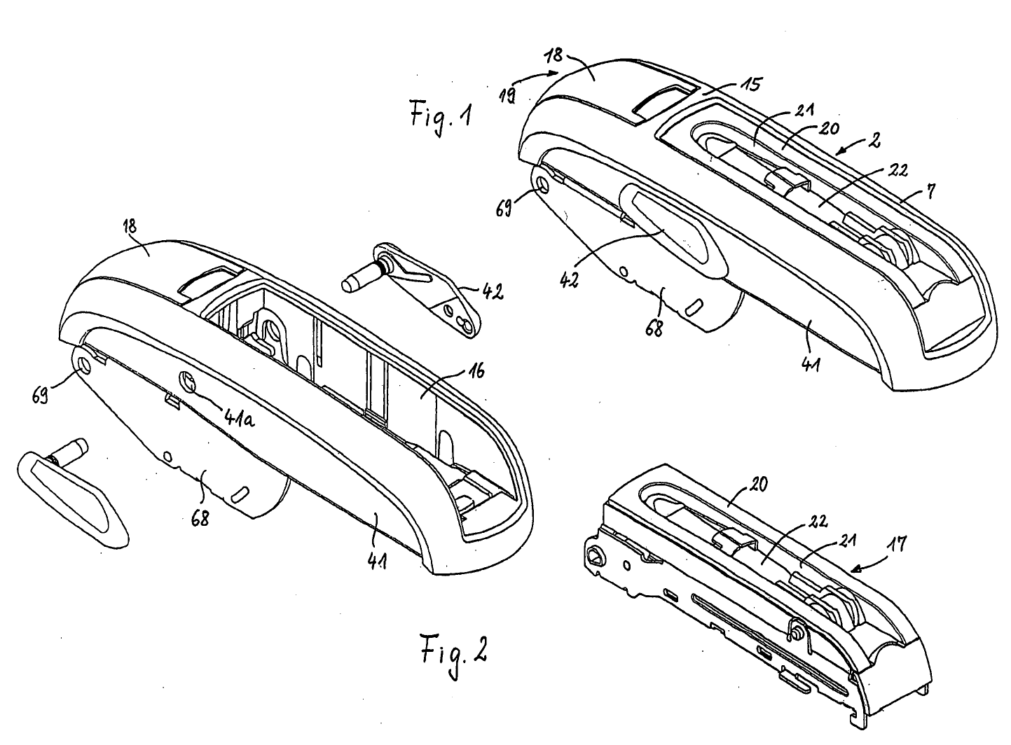

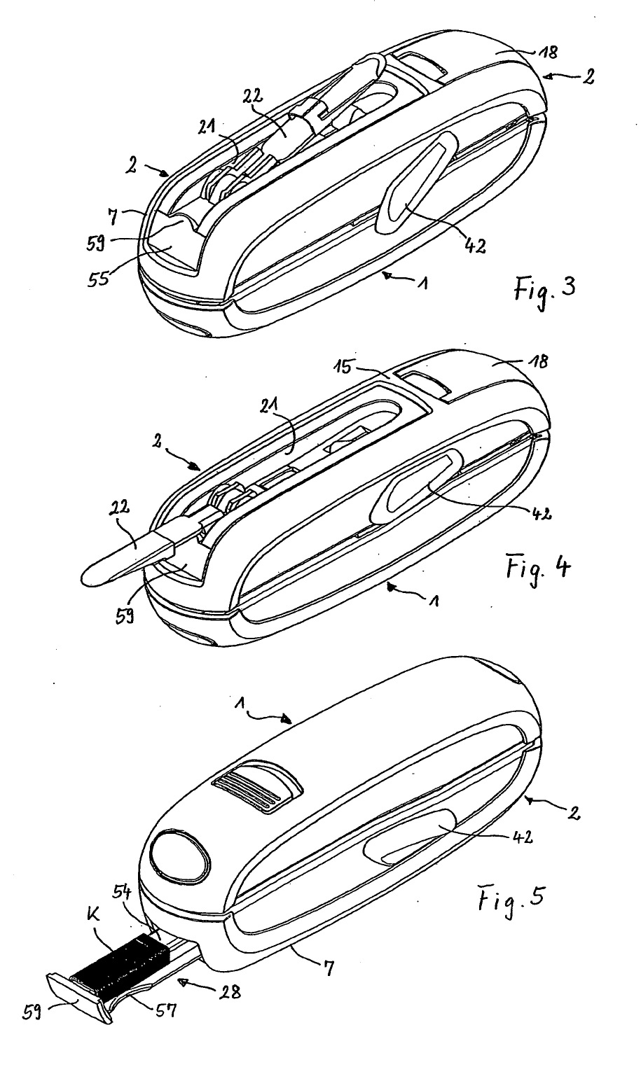

The lifting device 34 serves, by virtue of the outer actuating lever 42 being actuated, for pivoting the staple remover 22 from its storage position, by means of the lifting nose 36, into an oblique opening position (FIGS. 3 and 10), in order that the staple remover 22 can then be easily gripped and swung out into its use position (FIG. 4).

The staple remover 22 is prestressed both into the storage position and into the use position by means of a leaf spring 45 which is fastened on the chassis 26. For this purpose, the leaf spring 45 has one end supported on the chassis 26, in the accommodating compartment of the latter, and has its central region extending through a corresponding opening to the other side of the chassis 26, where it is secured on a protuberance 46, and has its fork-like spring section projecting into a recess 47 of the chassis 26, in order to act on the flattened sections of side walls 24a of the shank 24 of the staple remover 22 which are directed toward it in the respective position, see FIGS. 7 and 8. The side walls 24a here project, through corresponding slots 48 in the covering 20, into the region of the recess 47.

The side plates 29 of the chassis 26 contain downwardly directed eyelets 49 for mounting the pin 23, said eyelets engaging over the covering 20 in the region of the openings for the pin 23.

The covering 20 has an opening 50, through which the lifting nose 36 engages with the staple remover 22.

The side walls 29 of the chassis 26 comprise beads 51 which extend in the longitudinal direction of the latter, while the drawer 28 has stepped side plates 52 which are accommodated in the region between the beads 51 and the base wall 53 of the chassis 26 for the purpose of guiding the drawer 28.

The drawer 28 comprises a saddle 54 on which a block of staples K (FIGS. 5 and 8) for the stapler can be fitted, said staple block serving as a supply of staples for the stapler. The saddle 54, which ends at a front wall 55 of the drawer 28, is recessed on the underside and forms a corresponding cavity, into which the fork-like spring section of the leaf spring 45 and the side walls 24a of the shank 24 of the staple remover 22 can extend, as well as lateral base-wall parts 56 which bear the side plates 52. The base-wall parts 56 are provided, adjacent to the front wall 55, with finger hollows 57, in order to make it easier to grip a staple block which is located on the saddle 54. A transverse wall 58 at the inner end of the saddle 54 bounds the depth to which the staple block K is pushed in.

The front wall 55 of the drawer 28 has, on the underside, a gripping element 59 which projects into the recess 21 of the covering 20 and is used for opening the drawer 28 manually.

The staple remover 22 is recessed in the region of the gripping element 59, with the result that, in the swung-out state, it rests. on the base wall 15 of the covering 20, which is supported on the base wall 53 of the chassis 26.

The saddle 54 expediently has, on its inner, top edge, a bead 61 which, in the pushed-in position of the drawer 28, interacts with a corresponding bead 62 on the intermediate base 27 for the purpose of latching the drawer 28 in the closed position.

In the border region of its side plates 29, the chassis 26 has slots 63, into which corresponding protuberances 64 on the intermediate base 27 can be latched. The installation module 17 is connected to the base-side component 2 via a suspension means 65, 66, 67, the housing shell 7, moreover, projecting beyond the accommodating space 16 on the base side, with the result that the covering 20 is secured correspondingly.

The base-side component 2 bears a U-shaped bearing block 68, of which the upwardly directed legs are each provided with a bore 69 for the swivel pin 3.

In the case of the embodiment illustrated in FIG. 11, the staple remover 22 can be raised into an oblique open position via a rocker 70, in order then for it to be possible to be gripped and swung out to the full extent. For this purpose, the rocker 70 is mounted on the chassis 26 by means of a pin 71 and, at one end, has an angled section 72a which projects through a base-side opening 73 in the covering 20 and can be actuated manually in order that a further angled section 72b at the other end acts on the shank 24 of the staple remover 22 and forces the latter into the oblique open position corresponding to FIG. 3.

In the case of the embodiment illustrated in FIG. 12, the staple remover 22 is provided, between the side walls of its shank 24, with a protrusion 74, which engages with a pulling element 76 which is arranged beneath the saddle 54 such that it can be displaced manually counter to the prestressing of a spring 75 supported on the covering 20, with the result that pulling of the pulling element 76 allows the protrusion 74 to be rotated and thus allows the staple remover 22 to be moved into its oblique open position. The pulling element 76 here is preferably subjected to the pulling action via actuating levers 42 or via a gearwheel/rack mechanism, which transmits the rotary movement of the actuating levers 42 into a pulling movement acting on the pulling element 76.

It is also possible, of course, for the swing-out systems described and shown in FIGS. 1 to 12 to act on a plurality of swing-out tools, as is described in detail in WO 99/20438.

In the case of the embodiment illustrated in FIG. 13, the staple remover 22 is arranged such that it can be pushed out of the recess 21 into its use position, for which purpose a corresponding slot 77 is provided in the covering 70. The slot 77 in the covering 20 is assigned a guide slot 78 in the adjacent base wall 53 of the chassis 26. The guide slot 78 is widened at two latching positions, corresponding to the storage position and the use position of the staple remover 22, to form a square latching recess 79 (only one is visible in FIG. 13). The staple remover 22 is fastened on a guide block 80 by way of its shank 24. The guide block has a stepped bore 81 which accommodates an arresting pin 83, which is prestressed outward by a spring 82 and has a square head 84 for engaging with the latching recesses 79. Located on that side of the base wall 53 which is directed away from the staple remover 22 is a plate 85 which is connected to the guide block 80 with two guide grooves being formed in the process, the latter engaging over the base wall 53 adjacent to the guide slot 78. The arresting pin 83 projects outward through the staple remover 22 and is located in a small hollow 86, in order to make it easier for it to be pressed in. By virtue of the arresting pin 83 being pressed in manually, counter to the force of the spring 82, by means of a finger, the head 84 is forced out of the latching recess 79, as a result of which the arresting of the staple remover 22 is released and the latter can be displaced.

Instead of the swing-out or push-out action, it is also possible for the staple remover 22 to be capable of being rotated about a pin, in a direction perpendicular to the plane of the base wall 53, between its storage position and use position and of being latched or locked in the end positions, the movement direction of the swing-out mechanism having to be adapted correspondingly.

The components contained in the installation module 17 may also be installed, as such, in the housing shell 7 and need not form a module, although this is preferred.

1. A multipurpose hand-held implement, in particular for office work, having a stapler which has a staple magazine (8), a staple driver (9) and an anvil (14) for folding over the ends of ejected staples, and having a component (2) which has a bearing plate (12) and a housing shell (7) with a base wall (15), which bound an accommodating space, the anvil (14) being accommodated in the region of the bearing plate (12), characterized in that the accommodating space accommodates an accommodating compartment with a drawer (28).

2. A multipurpose hand-held implement, in particular for office work, having a stapler which has a staple magazine (8), a staple driver (9) and an anvil (14) for folding over the ends of ejected staples, having a component (2) which has a bearing plate (12) and a housing shell (7) with a base wall (15), which bound an accommodating space, the anvil (14) being accommodated in the region of the bearing plate (12), and having a staple remover (22) which can be moved between a use position and a storage position and, in the storage position, is accommodated by a recess (21) in the base wall (15) of the housing shell (7), the implement forming a handle for the staple remover (22) in its use position, in it projects beyond the housing shell (7), characterized in that a closable accommodating compartment for staples is arranged between the base wall (15) and the bearing plate (12).

3. The implement as claimed in claim 2, characterized in that the accommodating compartment accommodates a drawer (28).

4. The implement as claimed in claim 1 or 3, characterized in that the drawer (28) can be drawn out essentially parallel to the bearing plate (12) and base wall (15).

5. The implement as claimed in one of claims 1 to 3, characterized in that the accommodating compartment is open toward one end side of the housing shell (7).

6. The implement as claimed in one of claims 1 and 3 to 5, characterized in that the drawer (28) has a saddle (54) on which a staple block can be fitted.

7. The implement as claimed in one of claims 1 and 3 to 6, characterized in that the drawer (28) is provided with a front wall (55) for closing the accommodating compartment.

8. The implement as claimed in claim 6 or 7, characterized in that the saddle (54) has gripping hollows (57) on the base side.

9. The implement as claimed in one of claims 1 and 3 to 8, characterized in that the drawer (28), in the pushed-in position, is latched in such that it can be unlatched.

10. The implement as claimed in one of claims 1 and 3 to 9, characterized in that the draw-out path of the drawer (28) is limited.

11. The implement as claimed in one of claims 1 and 3 to 10, characterized in that there is provided a staple remover (22) which can be moved between a use position and a storage position and, in the storage position, is accommodated by a recess (21) in the base wall (15) of the housing shell (7), the implement forming a handle for the staple remover (22) in its use position, in it projects beyond the housing shell (7).

12. The implement as claimed in claim 1 or 11, characterized in that the staple remover (22) can be swung out.

13. The implement as claimed in claim 12, characterized in that the staple remover (22) can be swung out about a pin (23) which runs transversely to the longitudinal direction of the component (2).

14. The implement as claimed in one of claims 1 and 11 to 13, characterized in that the staple remover (22) is prestressed into its open position and into its closed position by a spring (45).

15. The implement as claimed in one of claims 1 to 14, characterized in that the accommodating compartment is bounded on the outside by a covering (20) which contains the recess (21).

16. The implement as claimed in one of claims 1 to 15, characterized in that the accommodating compartment is bounded on the inside by an intermediate base (27).

17. The implement as claimed in one of claims 1 to 16, characterized in that the accommodating compartment is bounded from the outside by a chassis (26).

18. The implement as claimed in one of claims 2 to 17, characterized in that the staple remover (22) and the accommodating compartment form part of an installation module (17) which can be inserted into the component (2) on the base side.

19. The implement as claimed in claim 18, characterized in that the installation module (17) is essentially flush with the component (2).

20. The implement as claimed in claim 18 or 19, characterized in that the installation module (17) comprises a chassis (26) which, in the direction of the outside, bears a covering (20) which contains the recess (21) and, in the direction of the inside, bears an intermediate base (27).

21. The implement as claimed in claim 20, characterized in that the chassis (26) has guides (51) for the drawer (28).

22. The implement as claimed in claim 20 or 21, characterized in that the chassis (26) has a base-side recess (47), into which the ends of the shank (24) of the staple remover (22) and the spring (45) project.

23. The implement as claimed in one of claims 2 to 22, characterized in that the staple remover (22) can be moved, via a manually actuable mechanism, into an oblique open position in relation to the base-side component (2).

24. The implement as claimed in claim 23, characterized in that the mechanism is mounted on the chassis (26).

25. The implement as claimed in claim 23 or 24, characterized in that the mechanism comprises a lifting device (34) which is spring-prestressed into its starting position and is mounted in the component (2) such that it can be pivoted against the staple remover (22).

26. The implement as claimed in claim 25, characterized in that the lifting device (34) comprises a partial toothing arrangement (38), which meshes with a separately mounted toothed segment (40) which can be rotated from the outside.

27. The implement as claimed in claim 26, characterized in that the toothed segment (40) is prestressed into the starting position.

28. The implement as claimed in claim 26 or 27, characterized in that the toothed segment (40) comprises two segment sections which are connected by a clip.

29. The implement as claimed in claim 23 or 24, characterized in that the mechanism has a manually actuable rocker (70), one end of which can be brought into active engagement with the staple remover (22).

30. The implement as claimed in claim 23 or 24, characterized in that the mechanism comprises a pulling element (76) which can be actuated manually counter to spring prestressing and via which it is possible to rotate a protrusion (74) which is fastened on the staple remover (22).

31. The implement as claimed in one of claims 2 to 11 and 13 to 30, characterized in that the staple remover (22) can be pushed out.

32. The implement as claimed in one of claims 2 to 11 and 13 to 30, characterized in that the staple remover (22) can be rotated into its use position.

33. The implement as claimed in one of claims 2 to 32, characterized in that the staple remover (22) can be latched in its storage position and in its use position.

34. The implement as claimed in claim 33, characterized in that the staple remover (22) can be pushed out via a guide slot (78) which is provided with two latching recesses (79) for an arresting pin (83) which can be actuated manually, counter to spring prestressing, from the outside.
